(19) United States
(12) Patent Application Publication
(10) Pub. No.: US 2022/0244590 A1
(43) Pub. Date: Aug. 4, 2022

(54) TOUCH CONTROL LIGHT ADJUSTABLE DEVICE

(71) Applicant: Edain Opto-electron, Ltd., Keelung City (TW)

(72) Inventors: Shin-Yi Cheng, New Taipei City (TW); Jan-Tian Lian, Keelung City (TW); Chien-Lin Pan, New Taipei City (TW)

(73) Assignee: Edain Opto-electron, Ltd., Keelung City (TW)

(21) Appl. No.: 17/578,450

(22) Filed: Jan. 19, 2022

(30) Foreign Application Priority Data
Jan. 29, 2021 (TW) 110103597

(51) Int. Cl. G02F 1/133; G02F 1/1334

(52) U.S. Cl. CPC G02F 1/13306; G02F 1/1334

(57) ABSTRACT

A touch control light adjustable device including a first transparent substrate, a macromolecule dispersed liquid crystal composite layer, a first touch control structure, and a driving circuit is provided. The first transparent substrate has a first surface and a second surface opposite to each other. The macromolecule dispersed liquid crystal composite layer is disposed on the first surface of the first transparent substrate. The first touch control structure is disposed on the second surface of the first transparent substrate. The macromolecule dispersed liquid crystal composite layer and the first touch control structure are electrically connected to the driving circuit. The driving circuit provides a voltage signal to drive the macromolecule dispersed liquid crystal composite layer based on a change of a capacitance value of at least one capacitor in the driving circuit by touching the surface of the first touch control structure.

### CROSS-REFERENCE TO RELATED APPLICATION

This application claims the priority benefit of Taiwan application serial no. 110103597, filed on Jan. 29, 2021. The entirety of the above-mentioned patent application is hereby incorporated by reference herein and made a part of this specification.

### BACKGROUND

### Technical Field

The disclosure relates to a light adjustable device, and in particularly, relates to a touch control light adjustable device.

### Description of Related Art

Along with continuous expansion of applications of electronic devices, the application of liquid crystal involves a variety of technical fields. For instance, a light control device is a liquid crystal element that may perform light adjustment by controlling light scattering in a liquid crystal layer. The light control devices are used in building materials such as window glass or room partitions, etc., or used in vehicle parts. Hard raw materials as well as soft raw materials such as a plastic film, etc. may both be adopted for the substrate of a light control device. By adjusting the voltage applied to the liquid crystal composition in the liquid crystal layer sandwiched by the substrates, the arrangement of molecules of the liquid crystal compound is changed, so that light scattering is controlled and light adjustment is thereby implemented. In some fields, the light control devices may be referred to as displays, optical shutters, smart windows, etc.

A macromolecule dispersed light control device has a polymer and a liquid crystal composition in the liquid crystal layer. Based on formation of a specific electric field, the liquid crystal composition may be aligned in the forward direction along the electric field. The light passing through the liquid crystal composition may be matched with the environmental macromolecules in the same direction to improve the light transmittance, such that the light control device may provide a transparent or opaque effect through the change of the electric field, such that the light control device may be expected to be used for intelligent shading or for privacy control windows.

At present, in order to further improve usability and operability of the light control devices or smart windows, development of a light adjustable device that may meet usage requirements of the human-machine interface is an important issue.

### SUMMARY

The disclosure is directed to a touch control light adjustable device featuring a simple manufacturing process, requiring reduced costs, and exhibiting improved usability and operability.

An embodiment of the disclosure provides a touch control light adjustable device including a first transparent substrate, a macromolecule dispersed liquid crystal composite layer, a first touch control structure, and a driving circuit. The first transparent substrate has a first surface and a second surface opposite to each other. The macromolecule dispersed liquid crystal composite layer is disposed on the first surface of the first transparent substrate. The first touch control structure is disposed on the second surface of the first transparent substrate. The macromolecule dispersed liquid crystal composite layer and the first touch control structure are electrically connected to the driving circuit. The driving circuit provides a voltage signal to drive the macromolecule dispersed liquid crystal composite layer based on a change of a capacitance value of at least one capacitor in the driving circuit by touching the surface of the first touch control structure.

Based on the above description, in the touch control light adjustable device of the embodiment of the disclosure, since the macromolecule dispersed liquid crystal composite layer and the first touch control structure are electrically connected to the driving circuit, a user may operate (for example, touch) a transparent conductive material of the first touch control structure to change the capacitance value of at least one capacitor in the driving circuit . The driving circuit may provide a voltage signal to the macromolecule dispersed liquid crystal composite layer based on the change in the capacitance value of at least one capacitor in the driving circuit caused by the user's operation to drive a corresponding area of the macromolecule dispersed liquid crystal composite layer to implement partial or overall light-transmitting and opaque changes. In this way, the touch control light adjustable device may implement light-transmitting and opaque changes through a user's touch operation, so as to achieve improved usability and operability. Further, the touch control light adjustable device of the embodiment may be manufactured through a simple manufacturing method, and cost saving may thus be achieved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic cross-sectional view of a touch control light adjustable device according to an embodiment of the disclosure.

FIG. 2A is a schematic top view of a touch control light adjustable device according to an embodiment of the disclosure.

FIG. 2B is a schematic top view of a touch control light adjustable device according to an embodiment of the disclosure.

FIG. 2C is a schematic top view of a touch control light adjustable device according to an embodiment of the disclosure.

FIG. 3 is a schematic cross-sectional view of a touch control light adjustable device according to another embodiment of the disclosure.

FIG. 4 is a schematic cross-sectional view of a touch control light adjustable device according to another embodiment of the disclosure.

FIG. 5 is a schematic cross-sectional view of a touch control light adjustable device according to another embodiment of the disclosure.

FIG. 6 is a schematic cross-sectional view of a touch control light adjustable device according to another embodiment of the disclosure.

FIG. 7 is a schematic cross-sectional view of a touch control light adjustable device according to still another embodiment of the disclosure.

### DESCRIPTION OF THE EMBODIMENTS

In the drawings of the disclosure, each of the drawings depicts typical features of methods, structures, and/or materials used in the particular exemplary embodiments. However, these drawings are not to be interpreted as limiting or limiting the scope or property covered by these exemplary embodiments. For example, for clarity's sake, relative size, thickness and position of each film layer, region and/or structure may be reduced or enlarged.

The terms “first”, “second”, etc., may be used for describing various elements, components, regions, layers and/or portions, but the elements, components, regions, layers and/or portions are not limited by these terms. These terms are only used for separating one element, component, region, layer or portion from another element, component, region, layer or portion. Therefore, the following discussed first “element”, “component”, “region”, “layer” or “portion” is used for distinguishing with a second “element”, “component”, “region”, “layer” or “portion”, and is not used for limiting a sequence of a specific element, component, region, layer and/or portion.

In the disclosure, the various embodiments described below may be mixed and matched without departing from the spirit and scope of the disclosure. For example, some features of one embodiment may be combined with some features of another embodiment to become yet another embodiment.

Reference will now be made in detail to the exemplary embodiments of the disclosure, and examples of the exemplary embodiments are illustrated in the accompanying drawings. Whenever possible, the same component symbols are used in the drawings and descriptions to indicate the same or similar parts. The disclosure may also be embodied in various different forms and should not be limited to the embodiments described herein. Thickness of a region used to represent an element or a film layer in the drawing may be exaggerated for clarity's sake. The same or similar reference numbers indicate the same or similar elements, which will not be repeated in the following paragraphs one by one. Directional terminology, such as “top,” “bottom,” “left,” “right,” “front,” “back,” etc., is used with reference to the orientation of the Figure(s) being described and are not intended to be limiting of the disclosure.

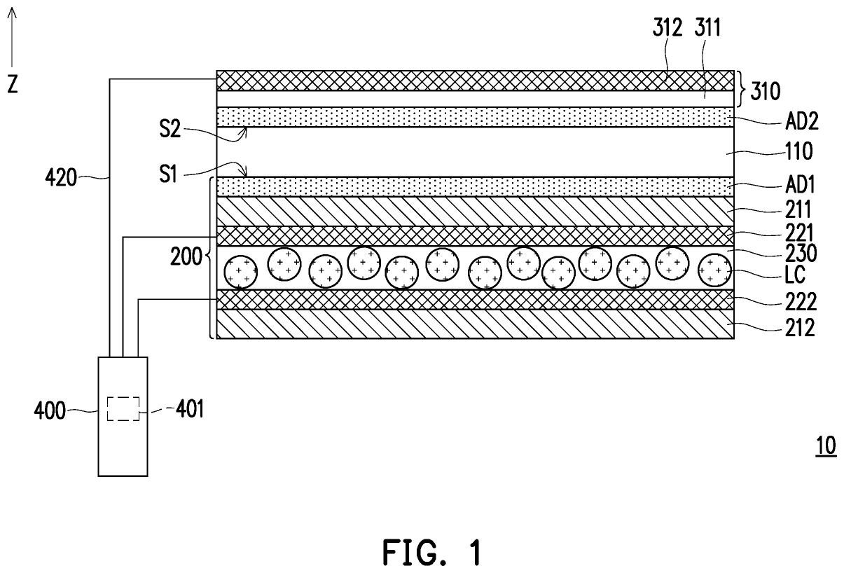

FIG. 1 is a schematic cross-sectional view of a touch control light adjustable device according to an embodiment of the disclosure. For clarity's sake of the drawings and convenience of description, several elements are omitted in FIG. 1. Referring to FIG. 1 first, a touch control light adjustable device 10 includes a first transparent substrate 110, a macromolecule dispersed liquid crystal composite layer 200, a first touch control structure 310, and a driving circuit 400. The macromolecule dispersed liquid crystal composite layer 200 and the first touch control structure 310 are respectively disposed on two opposite surfaces S1 and S2 of the first transparent substrate 110. The macromolecule dispersed liquid crystal composite layer 200 and the first touch control structure 310 are electrically connected to the driving circuit 400. In this embodiment, since the driving circuit 400 may provide a voltage signal to drive liquid crystal molecules in the macromolecule dispersed liquid crystal composite layer 200 based on a change in a capacitance value of at least one capacitor 401 in the driving circuit 400 by touching the surface of the first touch control structure 310, an external electric field may be generated in the macromolecule dispersed liquid crystal composite layer 200 to control a rotation direction of the liquid crystal molecules. Therefore, the liquid crystal molecules may control a light transmittance of the macromolecule dispersed liquid crystal composite layer 200, so that the macromolecule dispersed liquid crystal composite layer 200 may be adjusted between a scattering state and a transparent state, and may exhibit an effect of grayscale display. In this way, the touch control light adjustable device 10 may feature improved usability and operability. In addition, the touch control light adjustable device 10 of this embodiment has a simple structure, may be manufactured through a simple manufacturing process, and may achieve cost saving.

Referring to FIG. 1 again, the first transparent substrate 110 has a first surface S1 and a second surface S2 opposite to each other. For the convenience of description, the first surface S1 is, for example, a lower surface of the first transparent substrate 110 in a normal direction (i.e., a Z-axis). The second surface S2 is, for example, an upper surface of the first transparent substrate 110 in the normal direction, but the disclosure is not limited thereto. In some embodiments, a material of the first transparent substrate 110 includes a rigid light-transmitting material or a soft light-transmitting material. For example, a material of the first transparent substrate 110 includes glass, polyethylene terephthalate (PET), acrylic plastic, crystal, or quartz. In other embodiments, the material of the first transparent substrate 110 includes polymethyl methacrylate (PMMA), polycarbonate (PC), polyethylene (PE), polyethersulfone (PES), polyethylene naphthalate (PEN), polyetheretherketone (PEEK), polyimide (PI), polyurethane (PU) or other suitable translucent materials, but the disclosure is not limited thereto. In some embodiments, on the Z-axis, a thickness of the first transparent substrate 110 is, for example, 10 μm to 1000 μm, or 1 cm to 50 cm, but the disclosure is not limited thereto. In the embodiment, the first transparent substrate 110 is, for example, glass, and the touch control light adjustable device 10 is smart glass capable of adjusting light transmittance.

The macromolecule dispersed liquid crystal composite layer 200 is disposed on the first surface S1 of the first transparent substrate 110. The macromolecule dispersed liquid crystal composite layer 200 is, for example, a polymer-dispersed liquid crystal (PDLC) composite layer. In detail, the macromolecule dispersed liquid crystal composite layer 200 includes a first transparent base board 211, a first transparent conductive layer 221, a macromolecule dispersed liquid crystal layer 230, a second transparent conductive layer 222, and a second transparent base board 212. The second transparent base board 212 is disposed opposite to the first transparent base board 211. In some embodiments, materials of the first transparent base board 211 and the second transparent base board 212 include polyethylene terephthalate (PET), polymethyl methacrylate (PMMA), polycarbonate (PC), polyethylene (PE), polyethersulfone (PES), polyethersulfone (PES), polyethylene naphthalate (PEN), polyetheretherketone (PEEK), polyimide (PI), polyurethane (PU), acrylic plastic or other suitable translucent materials, which is not limited by the disclosure. In other embodiments, the first transparent base board 211 and the second transparent base board 212 may be glass, quartz or crystal, but the disclosure is not limited thereto.

In some other embodiments, the macromolecule dispersed liquid crystal composite layer 200 may be replaced by an electrochromic material layer. For example, the aforementioned macromolecule dispersed liquid crystal layer 230 may include an electrochromic material. The electrochromic material may produce a stable and reversible color change phenomenon under a function of an external electric field, so as to change a reflectance, a transmittance, or an absorption rate of the material layer. In some embodiments, the electrochromic material may be a liquid, gel or solid material, including polyaniline, viologen compound ((C₅H₅NR)₂ⁿ⁺), tungsten polyacid or tungsten trioxide, etc., but the disclosure is not limited thereto.

The first transparent conductive layer 221 is disposed on the first transparent base board 211. The second transparent conductive layer 222 is disposed on the second transparent base board 212. In some embodiments, the first transparent conductive layer 221 and the second transparent conductive layer 222 are located between the first transparent base board 211 and the second transparent base board 212. The first transparent conductive layer 221 and the second transparent conductive layer 222 are, for example, conductive materials with high light transmittance. The above high light transmittance may be defined as a light transmittance of 60% to 98%, but the disclosure is not limited thereto. Materials of the first transparent conductive layer 221 and the second transparent conductive layer 222 include metals or metal oxides, such as silver, nanosilver, indium tin oxide (ITO), antimony tin oxide (ATO), fluorine tin oxide (FTO), aluminum zinc oxide (AZO), gallium zinc oxide (GZO), indium zinc oxide (IZO), carbon nanotube, grapheme, or other suitable transparent conductive materials, but the disclosure is not limited thereto. The first transparent conductive layer 221 and the second transparent conductive layer 222 are, for example, patterned conductive patterns, and may produce an external electric field between the first transparent conductive layer 221 and the second transparent conductive layer 222 after conduction, but the disclosure is not limited thereto.

The macromolecule dispersed liquid crystal layer 230 (or electrochromic material layer) is disposed between the first transparent conductive layer 221 and the second transparent conductive layer 222. The macromolecule dispersed liquid crystal layer 230 is, for example, in the form of micron-sized liquid crystal molecules LC droplets dispersed in an organic solid polymer substrate. Since optical axes of the droplets composed of liquid crystal molecules LC are in free orientations, refractive indexes thereof do not match a refractive index of the substrate, and when light passes through the substrate, it is strongly scattered by the liquid crystal droplets to present a foggy and opaque milky white state or a translucent state. When an external electric field is applied, the optical axis orientations of the liquid crystal droplets may be adjusted, so that when the refractive indexes of the liquid crystal droplets and the substrate are matched, a transparent state is presented; on the contrary, when the external electric field is removed, the liquid crystal droplets may restore the original scattering state, i.e., to present a foggy state. In brief, the macromolecule dispersed liquid crystal layer 230 may provide control of the light transmittance of the touch control light adjustable device 10 to achieve technical effects of turning on (i.e., the transparent state) and turning off (i.e., the scattering state). In some embodiments, the light transmittance of the macromolecule dispersed liquid crystal layer 230 may also be changed by an intensity of an external electric field, so as to achieve a grayscale display effect. In other words, the macromolecule dispersed liquid crystal layer 230 may achieve the effects of no light penetration, only partial light penetration, most light penetration or complete light penetration, but the disclosure is not limited thereto.

The first conductive layer 221 and the second conductive layer 222 are electrically connected to the driving circuit 400. The driving circuit 400 is, for example, an integrated circuit (IC), a chip, a chip on film (COF) or a printed circuit board (PCB), but the disclosure is not limited thereto. The first conductive layer 221 and the second conductive layer 222 are, for example, electrically connected to the driving circuit 400 through a circuit 420. The driving circuit 400 may transmit a voltage signal to the first conductive layer 221 or the second conductive layer 222 to drive a corresponding area of the macromolecule dispersed liquid crystal composite layer 200 (or the electrochromic material layer) to perform partial or overall light-transmitting or opaque changes. For example, the macromolecule dispersed liquid crystal composite layer 200 (or the electrochromic material layer) may be turned on (the transparent state) so that a user may observe image light passing through the macromolecule dispersed liquid crystal composite layer 200. Alternatively, the macromolecule dispersed liquid crystal composite layer 200 (or the electrochromic material layer) may be turned off (the scattered state) and fogged, so that the user cannot observe or obscurely observe the image light penetrating through the macromolecule dispersed liquid crystal composite layer 200.

In some embodiments, the touch control light adjustable device 10 may selectively include a first optical adhesive layer AD1. The first optical adhesive layer AD1 is disposed on the first surface S1 of the first transparent substrate 110 and is located between the first transparent substrate 110 and the macromolecule dispersed liquid crystal composite layer 200. The first optical adhesive layer AD1 may fix the macromolecule dispersed liquid crystal composite layer 200 to the first transparent substrate 110. The first optical adhesive layer AD1 may be optically clear adhesive or optically clear tape, but the disclosure is not limited thereto.

The first touch control structure 310 is disposed on the second surface S2 of the first transparent substrate 110. The first touch control structure 310 is, for example, a touch control film, which includes a transparent material layer 311 and a transparent conductive material layer 312. The transparent conductive material layer 312 is disposed on the transparent material layer 311. From another point of view, the transparent material layer 311 is located between the transparent conductive material layer 312 and the first transparent substrate 110.

The material of the transparent material layer 311 includes light-transmitting plastic, such as polyethylene terephthalate, polyethylene, polyimide, nylon, polyurethane, or acrylic plastic. In some embodiments, the transparent material layer 311 may also include polymethyl methacrylate, polycarbonate, polyethylene, polyethersulfone, polyethylene naphthalate, polyetheretherketone, or other suitable light-transmitting materials, but the disclosure is not limited thereto. In some embodiments, on the Z-axis, a thickness of the transparent material layer 311 is, for example, 10 μm to 1000 μm, or 1000 μm to 10000 μm, but the disclosure is not limited thereto. In some embodiments, a thickness of the first transparent substrate 110 may be greater than or equal to the thickness of the transparent material layer 311, but the disclosure is not limited thereto.

The transparent conductive material layer 312 is, for example, applied as a touch control conductive layer. A material of the transparent conductive material 312 layer includes metal or metal oxides, such as silver, nanosilver, indium tin oxide, antimony tin oxide, fluorine tin oxide, aluminum zinc oxide, gallium zinc oxide, indium zinc oxide, carbon nanotubes, graphene or other suitable transparent conductive materials, but the disclosure is not limited thereto. The transparent conductive material 312 may be a patterned conductive pattern or disposed on the entire transparent material layer 311, but the disclosure is not limited thereto.

In some embodiments, the first touch control structure 310 may be disposed on the entire second surface S2 of the first transparent substrate 110, but the disclosure is not limited thereto. In other embodiments, the first touch control structure 310 may also be disposed on a part of the first transparent substrate 110. In other words, on the Z-axis, the first touch control structure 310 may be overlapped with at least a part of the first transparent substrate 110, but the disclosure is not limited thereto.

In some embodiments, the touch control light adjustable device 10 may selectively include a second optical adhesive layer AD2. The second optical adhesive layer AD2 is disposed on the second surface S2 of the first transparent substrate 110 and is located between the first transparent substrate 110 and the first touch control structure 310. The second optical adhesive layer AD2 may fix the first touch control structure 310 to the first transparent substrate 110. A material of the second optical adhesive layer AD2 may be the same to the material of the first optical adhesive layer AD1, so that details thereof are not repeated here.

It should be noted that the transparent conductive material 312 of the first touch control structure 310 is electrically connected to the driving circuit 400. The transparent conductive material 312 is, for example, electrically connected to the driving circuit 400 through the circuit 420. The macromolecule dispersed liquid crystal composite layer 200 is electrically connected to the driving circuit 400. In some embodiments, the user may change a capacitance value of at least one capacitor 401in the driving circuit 400 by operating (for example, touching) the transparent conductive material 312 of the first touch control structure 310. The driving circuit 400 may provide a voltage signal to the macromolecule dispersed liquid crystal composite layer 200 based on a change of the capacitance value of at least one capacitor 401 in the driving circuit 400 caused by the user's operation to drive the corresponding area of the macromolecule dispersed liquid crystal composite layer 200 (or the electrochromic material layer) to perform partial or overall light-transmitting or opaque changes. In this way, the touch control light adjustable device 10 may perform light-transmitting or opaque changes through a touch operation of the user, and thereby providing improved usability and operability.

A manufacturing method of the touch control light adjustable device 10 of to an embodiment of the disclosure is briefly described below.

First, the first transparent substrate 110 is provided.

Next, the first optical adhesive layer AD1 or the second optical adhesive layer AD2 are selectively disposed on the first surface S1 or the opposite second surface S2 of the first transparent substrate 110, respectively.

Then, the macromolecule dispersed liquid crystal composite layer 200 is disposed on the first surface S1 of the first transparent substrate 110. In the embodiment, the first optical adhesive layer AD1 is disposed between the first transparent substrate 110 and the macromolecule dispersed liquid crystal composite layer 200. In some embodiments, the macromolecule dispersed liquid crystal composite layer 200 includes the first transparent base board 211, the first transparent conductive layer 221, the macromolecule dispersed liquid crystal layer 230 (or the electrochromic material layer), the second transparent conductive layer 222 and the second transparent base board 212 stacked from top to bottom on the Z-axis. The first optical adhesive layer AD1 is disposed between the first transparent substrate 110 and the first transparent base board 211.

Next, the first touch control structure 310 is disposed on the second surface S2 of the first transparent substrate 110. In this embodiment, the second optical adhesive layer AD2 is disposed between the first transparent substrate 110 and the first touch control structure 310. In some embodiments, the macromolecule dispersed liquid crystal composite layer 200 includes the transparent conductive material 312 and the transparent material layer 311 stacked from top to bottom on the Z-axis. The second optical adhesive layer AD2 is disposed between the first transparent substrate 110 and the transparent material layer 311.

The macromolecule dispersed liquid crystal composite layer 200 and the first touch control structure 310 are then electrically connected to the driving circuit 400 through the circuit 420. In other embodiments, the macromolecule dispersed liquid crystal composite layer 200 may be electrically connected to the driving circuit 400 and the first touch control structure 310 may be electrically connected to the driving circuit 400 after the step of arranging the macromolecule dispersed liquid crystal composite layer 200 and the step of arranging the first touch control structure 310 are respectively completed. A sequence of the manufacturing process is not particularly limited in the disclosure. Manufacturing of the touch control light adjustable device 10 is substantially completed so far.

It should be noted that according to the manufacturing method of the touch control light adjustable device 10 of the embodiment, since the macromolecule dispersed liquid crystal composite layer 200 and the first touch control structure 310 may be simply and directly disposed on the two opposite surfaces S1 and S2 of the first transparent substrate 110, respectively, and are then electrically connected to the driving circuit 400 to complete the manufacturing process, the touch control light adjustable device 10 may thereby feature a simple structure, requires only a simple manufacturing process, and may achieve cost saving. The touch control light adjustable device 10 of the embodiment is suitable for being used as a building window, which may be used as light-transmitting glass in the transparent state, and used as opaque glass in the scattering state to meet requirements of privacy. In addition, the touch control light adjustable device 10 may also be applied to outdoor multimedia billboards, windows of vehicles (or carriers), or projection touch multimedia systems.

In brief, in the touch control light adjustable device 10 of an embodiment of the disclosure, since the macromolecule dispersed liquid crystal composite layer 200 and the first touch control structure 310 are electrically connected to the driving circuit 400, the user may operate (for example, touch) the transparent conductive material 312 of the first touch control structure 310 to change a capacitance value of at least one capacitor 401 in the driving circuit 400. The driving circuit 400 may provide a voltage signal to the macromolecule dispersed liquid crystal composite layer 200 based on the change of the capacitance value of at least one capacitor 401 in the driving circuit 400 cause by the user's operation to drive the corresponding area of the macromolecule dispersed liquid crystal composite layer 200 to implement partial or overall light-transmitting and opaque changes. In this way, the touch control light adjustable device 10 may implement light-transmitting and opaque changes through a user's touch operation, so as to achieve effects of improved usability and operability. In addition, according to the manufacturing method of the touch control light adjustable device 10 of the embodiment, the macromolecule dispersed liquid crystal composite layer 200 and the first touch control structure 310 may be simply and directly disposed on the two opposite surfaces S1 and S2 of the first transparent substrate 110, respectively, and are then electrically connected to the driving circuit 400 to complete the manufacturing process. Therefore, the touch control light adjustable device 10 may feature a simple structure, requires only a simple manufacturing process, and may achieve cost saving.

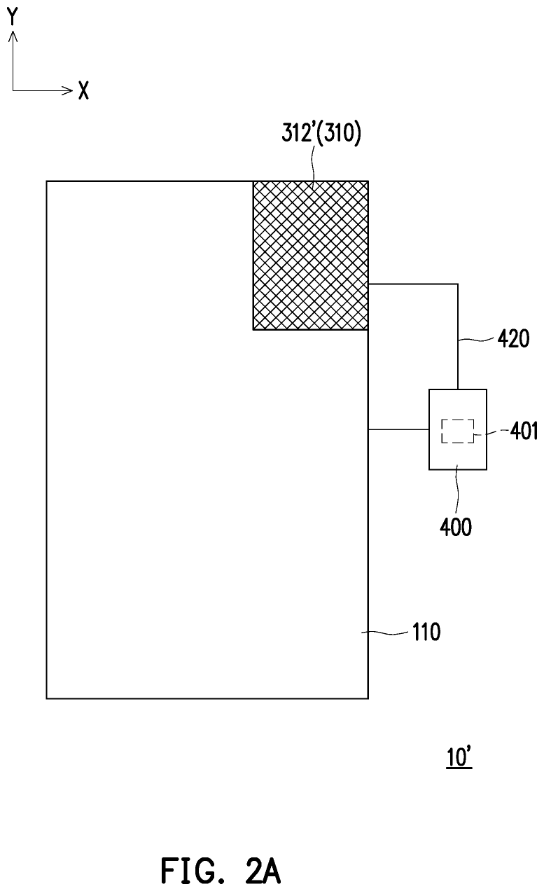

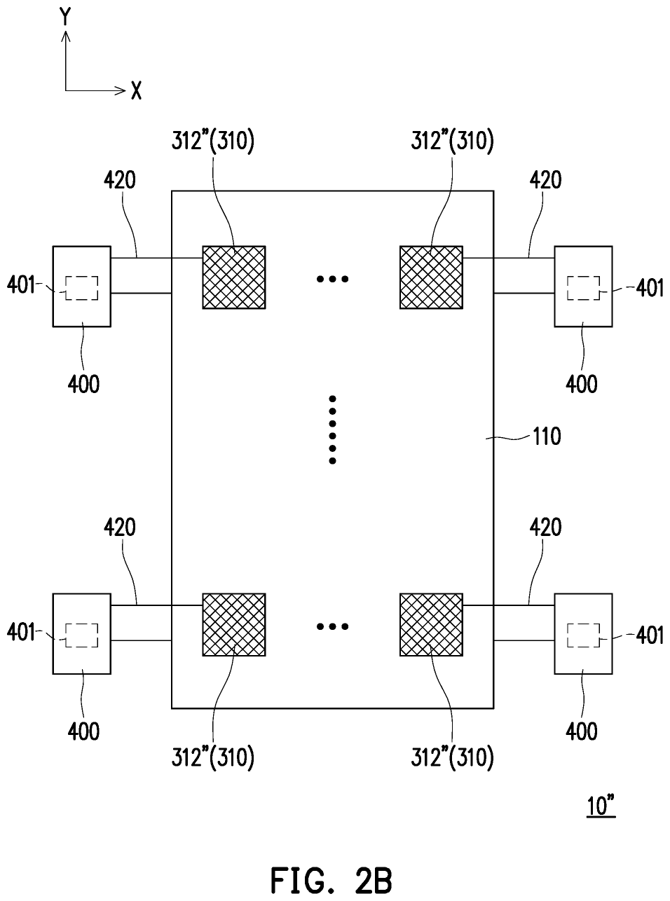

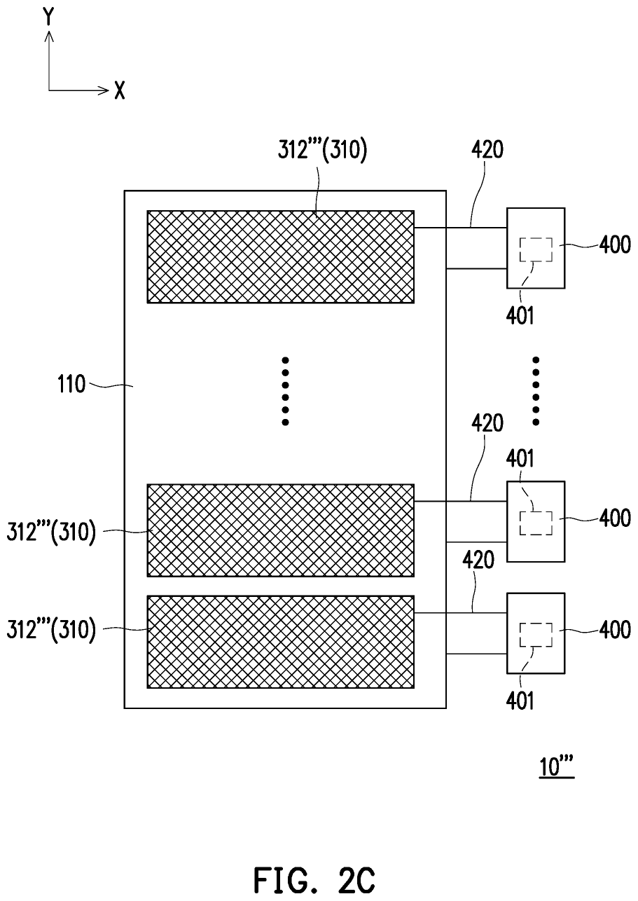

FIG. 2A is a schematic top view of a touch control light adjustable device according to an embodiment of the disclosure. For clarity's sake of the drawing and convenience of description, several elements are omitted in FIG. 2A. The touch control light adjustable device 10 shown in FIG. 1 is, for example, provided with the macromolecule dispersed liquid crystal composite layer 200 and the first touch control structure 310 on the entire surface of the second surface S2 of the first transparent substrate 110, so that the user may operate on any surface position of the touch control light adjustable device 10 to control the macromolecule dispersed liquid crystal composite layer 200 of the touch control light adjustable device 10 to change between the transparent state or the scattering state (or change a grayscale display). In the embodiment shown in FIG. 2A, the first touch control structure 310 (for example, indicated in FIG. 2A by a transparent conductive material 312′) of a touch control light adjustable device 10′ may be partially disposed on the first transparent substrate 110. For example, the transparent conductive material 312′ is overlapped with an upper right corner of the first transparent substrate 110, but the disclosure is not limited thereto. In other embodiments, the transparent conductive material 312′ may be overlapped with other corners of the first transparent substrate 110, for example, overlapped with a lower right, an upper left, or a lower left corner of the first transparent substrate 110 on an X-axis or a Y-axis. In some other embodiments, the transparent conductive material 312′ may not be disposed at the corners of the first transparent substrate 110, but disposed at the middle, but the disclosure is not limited thereto. In the embodiment, the X-axis may be perpendicular to the Y-axis, but the disclosure is not limited thereto.

In this embodiment, the macromolecule dispersed liquid crystal composite layer (shown in FIG. 1) may be provided on the entire surface of the first transparent substrate 110, but the disclosure is not limited thereto. In some embodiments, the macromolecule dispersed liquid crystal composite layer may also be correspondingly overlapped with the first touch control structure 310. For example, the macromolecule dispersed liquid crystal composite layer may be correspondingly overlapped with the transparent conductive material 312′ (in FIG. 2A, since it is a direction of observing the transparent conductive material 312′, the macromolecule dispersed liquid crystal composite layer is omitted). In this way, it may achieve the touch control and display functions only in a partial area of the touch control light adjustable device 10′, but the disclosure is not limited thereto. The driving circuit 400 is electrically connected to the macromolecule dispersed liquid crystal composite layer (shown in FIG. 1) and the first touch control structure 310. Under the above configuration, the user may control the touch control light adjustable device 10′ by operating a specific area, so as to reduce accidental touches of the touch control light adjustable device 10′. In addition, the cost of the touch control light adjustable device 10′ may be further saved or performance thereof may be improved. In addition, the touch control light adjustable device 10′ may also achieve the same effect as that of the aforementioned embodiment.

It should be noticed that reference numbers of the components and a part of contents of the aforementioned embodiment are also used in the following embodiment, where the same reference numbers denote the same or like components, and descriptions of the same technical contents are omitted. The aforementioned embodiment may be referred for descriptions of the omitted parts, and detailed descriptions thereof are not repeated in the following embodiment.

FIG. 2B is a schematic top view of a touch control light adjustable device according to an embodiment of the disclosure. For the clarity's sake of the drawings and the convenience of description, several elements are omitted in FIG. 2B. Referring to FIG. 2A and FIG. 2B, a touch control light adjustable device 10″ of the embodiment is similar to the touch control light adjustable device 10′ of FIG. 2A, and a main difference there between is that the first touch control structure 310 (indicated by a transparent conductive material 312″ in FIG. 2B) of the touch control light adjustable device 10″ may be one or plural, and a plurality of the first touch control structures 310 may be arranged in an array on the first transparent substrate 110. For example, the plurality of first touch control structures 310 and the transparent conductive materials 312″ thereof may be arranged close to the four corners of the first transparent substrate 110, but the disclosure is not limited thereto. In some embodiments, the plurality of first touch control structures 310 may also be arranged in an array on the X-axis and the Y-axis. For example, the plurality of first touch control structures 310 may be arranged in a row on the X-axis, and the plurality of first touch control structures 310 of a plurality of rows may be arranged along the Y-axis. In this way, the first touch control structure 310 may be disposed at any position on the first transparent substrate 110. In some other embodiments, when there is one first touch control structure 130, the first touch control structure 310 may also be arbitrarily disposed at any position on the first transparent substrate 110, including a part near a center, a part near a corner, or a part near an edge, but the disclosure is not limited thereto.

In the embodiment, the macromolecule dispersed liquid crystal composite layer (shown in FIG. 1) may be disposed on the entire surface of the first transparent substrate 110, but the disclosure is not limited thereto. In some embodiments, a quantity of the macromolecule dispersed liquid crystal composite layer may be one or plural. A plurality of macromolecule dispersed liquid crystal composite layers may be arranged in an array along the X-axis and the Y-axis on the first transparent substrate 110. For example, the plurality of macromolecule dispersed liquid crystal composite layers may be arranged in an array in overlap with a plurality of the first touch control structures 310. In other words, each macromolecule dispersed liquid crystal composite layer may be correspondingly overlapped with each transparent conductive material 312″ (in FIG. 2B, since it is a direction of observing the transparent conductive material 312″, the macromolecule dispersed liquid crystal composite layer is omitted). A plurality of driving circuits 400 may be electrically connected to the plurality of macromolecule dispersed liquid crystal composite layers (shown in FIG. 1) and the plurality of first touch control structures 310. In this way, it may achieve the touch control and display functions in partial or all areas of the touch control light adjustable device 10″, but the disclosure is not limited thereto.

Under the above configuration, the user may operate a specific area to control the touch control light adjustable device 10″, so as to reduce accidental touches of the touch control light adjustable device 10″. In addition, the touch control light adjustable device 10″ may have a large display area and/or a light-transmitting area to achieve good display/optical quality. In addition, the touch control light adjustable device 10″ may also achieve the same effect as that of the aforementioned embodiment.

FIG. 2C is a schematic top view of a touch control light adjustable device according to an embodiment of the disclosure. For clarity's sake and convenience of description, several elements are omitted in FIG. 2. Referring to FIG. 2A and FIG. 2C, a touch control light adjustable device 10′″ of the embodiment is similar to the touch control light adjustable device 10′ of FIG. 2A, and a main difference there between is that a quantity of the first touch control structures 310 (indicated by a transparent conductive material 312′″ in FIG. 2C) of the touch control light adjustable device 10′″ may be one or plural, and each of the first touch control structures 310 may be disposed across the first transparent substrate 110. For example, each first touch control structure 310 may be arranged on the first transparent substrate 110 from left to right, and the plurality of the first touch control structures 310 may be arranged along the Y-axis. In other words, the plurality of first touch control structures 310 may be arranged in a plurality of areas from top to bottom (or from bottom to top) on the first transparent substrate 110 shown in FIG. 2C.

In addition, the macromolecule dispersed liquid crystal composite layer (shown in FIG. 1) may be disposed on the entire surface of the first transparent substrate 110, but the disclosure is not limited thereto. In some embodiments, a quantity of the macromolecule dispersed liquid crystal composite layer may be one or plural. A plurality of the macromolecule dispersed liquid crystal composite layers may be arranged on the first transparent substrate 110 along the Y-axis. For example, the plurality of macromolecule dispersed liquid crystal composite layers may be arranged in partitions in overlap with a plurality of the first touch control structures 310 on the first transparent substrate 110. In other words, each macromolecule dispersed liquid crystal composite layer may be correspondingly overlapped with each transparent conductive material 312′″ (in FIG. 2B, since it is a direction of observing the transparent conductive material 312′″, the macromolecule dispersed liquid crystal composite layer is omitted). A plurality of driving circuits 400 may be electrically connected to the plurality of macromolecule dispersed liquid crystal composite layers (shown in FIG. 1) and the plurality of first touch control structures 310. In this way, it may achieve the touch control and display functions in partial or all areas of the touch control light adjustable device 10′″, but the disclosure is not limited thereto.

Under the above configuration, the user may operate one or a plurality of the first touch control structures 310 to switch the transparent state or the scattering state of one or a plurality of the macromolecule dispersed liquid crystal composite layers in partitions. In other words, the users may make any of the macromolecule dispersed liquid crystal composite layers to be transparent or foggy according to an actual need. For example, the macromolecule dispersed liquid crystal composite layer at the top may transmit light and the macromolecule dispersed liquid crystal composite layer at the bottom may be fogged, or the macromolecule dispersed liquid crystal composite layer near the middle may be fogged and the macromolecule dispersed liquid crystal composite layers located at the upper and lower ends may transmit light, but the disclosure is not limited thereto. In addition, taking the macromolecule dispersed liquid crystal composite layer disposed on the entire surface of the first transparent substrate 110 as an example, by operating any one of the first touch control structures 310, the entire surface of the touch control light adjustable device 10′″ may be fogged or transparent, but the disclosure is not limited thereto.

Moreover, the touch control light adjustable device 10′″ may also achieve the same effect as that of the aforementioned embodiment.

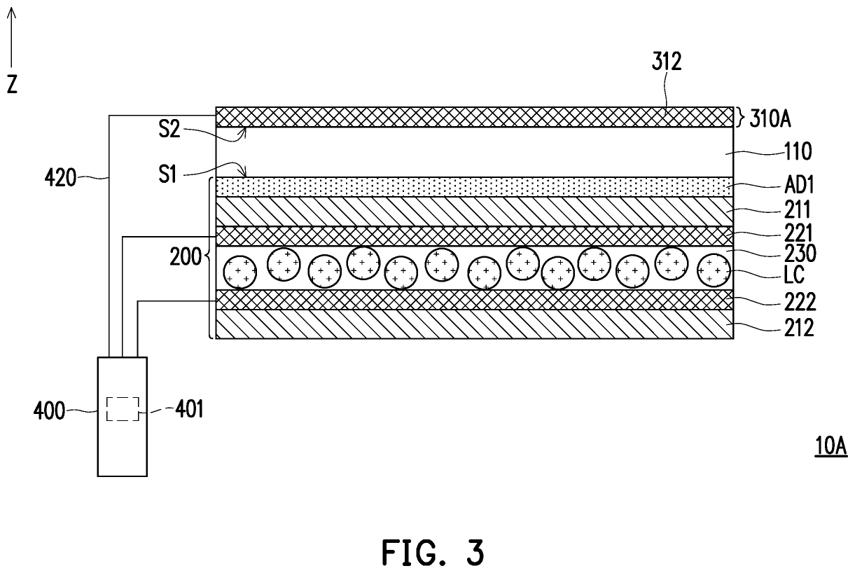

FIG. 3 is a schematic cross-sectional view of a touch control light adjustable device according to another embodiment of the disclosure. For the clarity's sake of the drawing and the convenience of description, several elements are omitted in FIG. 3. Referring to FIG. 3 and FIG. 1, a touch control light adjustable device 10A of the embodiment is similar to the touch control light adjustable device 10 of FIG. 1 and a main difference there between is that a first touch control structure 310A includes the transparent conductive material layer 312 and omits the transparent material layer. In some embodiments, the transparent conductive material layer 312 may be directly disposed on the second surface S2 of the first transparent substrate 110. A method for forming the transparent conductive material layer 312 may include physical vapor deposition (PVD), chemical vapor deposition (CVD), or a wet coating manufacturing process (for example, including spin coating) or other appropriate manufacturing processes. In this way, the first touch control structure 310A may be simply formed on the first transparent substrate 110 by a deposition or coating manufacturing process. Therefore, the structure of the touch control light adjustable device 10A may be further simplified and a thickness thereof may be reduced. In addition, the touch control light adjustable device 10A may also have the advantage of simplified manufacturing process and cost-saving. In addition, the touch control light adjustable device 10A may also achieve the same effect as that of the aforementioned embodiment.

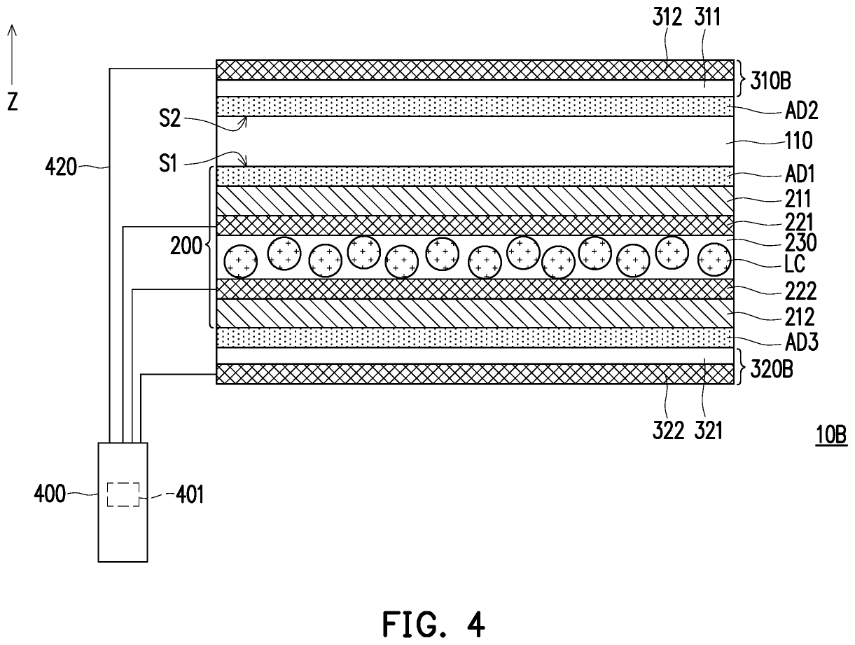

FIG. 4 is a schematic cross-sectional view of a touch control light adjustable device according to another embodiment of the disclosure. For the clarity's sake of the drawing and the convenience of description, several elements are omitted in FIG. 4. Referring to FIG. 4 and FIG. 1, a touch control light adjustable device 10B of the embodiment is similar to the touch control light adjustable device 10 of FIG. 1, and a main difference there between is that the touch control light adjustable device 10B further includes a second touch control structure 320B. For example, a first touch control structure 310B is disposed on the second surface S2 of the first transparent substrate 110. The second touch control structure 320B is disposed on the second transparent base board 212 of the macromolecule dispersed liquid crystal composite layer 200. In other words, the macromolecule dispersed liquid crystal composite layer 200 is located between the first transparent substrate 110 and the second touch control structure 320B.

In some embodiments, a third optical adhesive layer AD3 may be selectively provided on the second transparent base board 212. The third optical adhesive layer AD3 is located between the second transparent base board 212 and the second touch control structure 320B. A material of the third optical adhesive layer AD3 is similar to the material of the first optical adhesive layer AD1, so that detail thereof is not be repeated here.

The second touch control structure 320B is similar to the first touch control structure 310B, and has a transparent material layer 321 and a transparent conductive material layer 322. The transparent material layer 321 is located between the second transparent base board 212 and the transparent conductive material layer 322. A material of the transparent material layer 321 is similar to the material of the transparent material layer 311, so that detail thereof is not repeated. A material of the transparent conductive material layer 322 is similar to the material of the transparent conductive material layer 312, so that detail thereof is not repeated.

In some embodiments, the first transparent conductive layer 221, the second transparent conductive layer 222, the transparent conductive material layer 312, and the transparent conductive material layer 322 are electrically connected to the driving circuit 400 through the circuit 420, respectively. Therefore, the macromolecule dispersed liquid crystal composite layer 200, the first touch control structure 310B, and the second touch control structure 320B are electrically connected to the driving circuit 400 to provide the touch control light adjustable device 10B with a touching function and a liquid crystal driving function.

Under the above configuration, the first touch structure 310B and the second touch structure 320B may be disposed on two opposite sides of the touch control light adjustable device 10B. In other words, the touch control light adjustable device 10B may be a smart window or a display device with a touch function on both sides. In this way, the user may operate the touch control light adjustable device 10B on any of the opposite surfaces of the touch control light adjustable device 10B to implement light-transmitting or opaque changes. In this way, the usability or operability of the touch control light adjustable device 10B may be further improved. In addition, the touch control light adjustable device 10B may also achieve the same effect as that of the aforementioned embodiment.

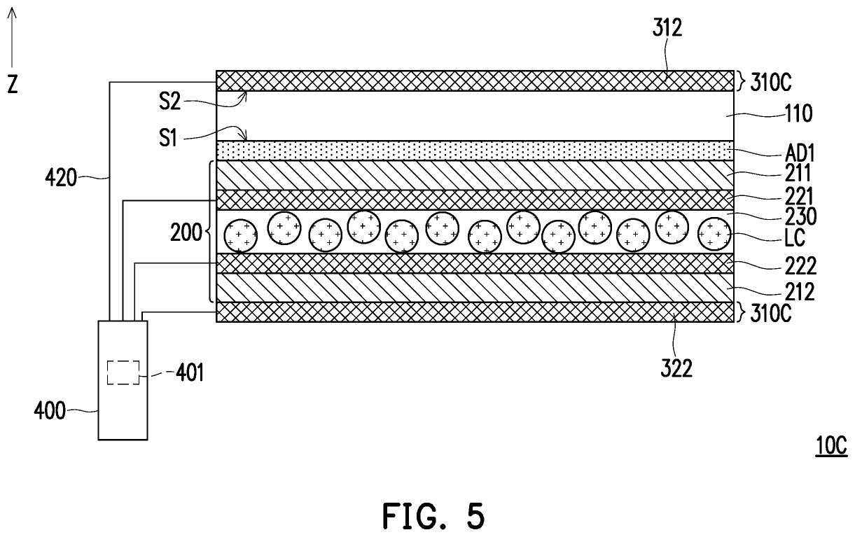

FIG. 5 is a schematic cross-sectional view of a touch control light adjustable device according to another embodiment of the disclosure. For clarity's sake of the drawing and convenience of description, several elements are omitted in FIG. 5. Referring to FIG. 5 and FIG. 4, a touch control light adjustable device 10C of the embodiment is similar to the touch control light adjustable device 10B of FIG. 4, and a main difference there between is that a first touch control structure 310C includes the transparent conductive material layer 312 and omits the transparent material layer, and a second touch control structure 320C includes the transparent conductive material layer 322 and omits the transparent material layer. The transparent conductive material layer 312 may be directly disposed on the second surface S2 of the first transparent substrate 110. The transparent conductive material layer 322 may be directly disposed on the second transparent base board 212. A formation method of the transparent conductive material layer 322 is similar to that of the transparent conductive material layer 312, so that detail thereof is not repeated. In this way, the first touch control structure 310C and the second touch control structure 320C may be simply formed by a deposition or coating manufacturing process. In this way, the structure of the touch control light adjustable device 10C may be further simplified and a thickness thereof may be reduced. In addition, the touch control light adjustable device 10C may also have the advantage of simplified manufacturing process and cost-saving.

In addition, the first transparent conductive layer 221, the second transparent conductive layer 222, the transparent conductive material layer 312, and the transparent conductive material layer 322 are electrically connected to the driving circuit 400 through the circuit 420, respectively. Therefore, the macromolecule dispersed liquid crystal composite layer 200, the first touch control structure 310C, and the second touch control structure 320C are electrically connected to the driving circuit 400 to provide the touch control light control device 10B with a touching function and a liquid crystal driving function.

In this way, the user may operate the touch control light adjustable device 10C on any of the opposite surfaces of the touch control light adjustable device 10C to implement light-transmitting or opaque changes. In this way, the usability or operability of the touch control light adjustable device 10C may be further improved. In addition, the touch control light adjustable device 10C may also achieve the same effect as that of the aforementioned embodiment.

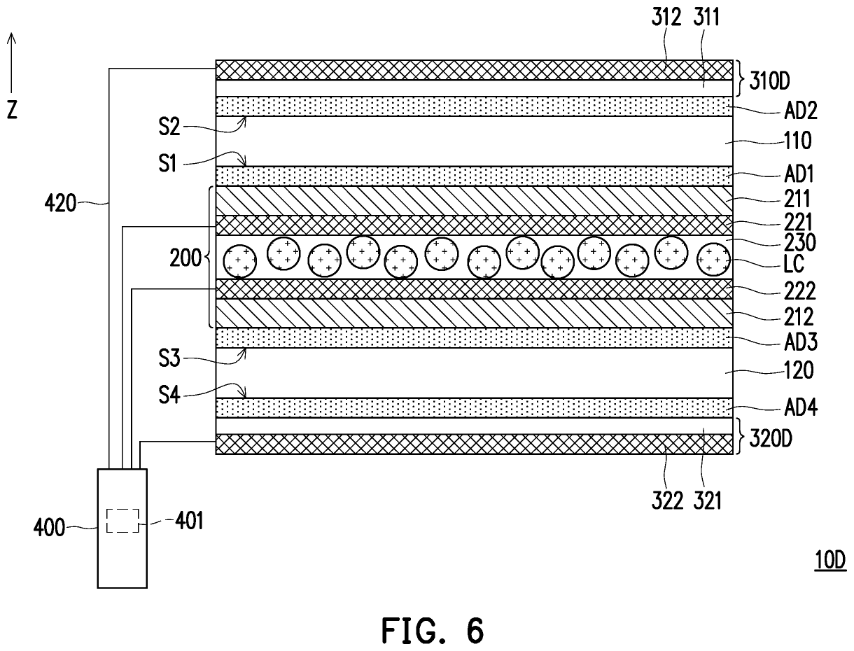

FIG. 6 is a schematic cross-sectional view of a touch control light adjustable device according to another embodiment of the disclosure. For the clarity's sake of the drawing and the convenience of description, several elements are omitted in FIG. 6. Referring to FIG. 6 and FIG. 1, a touch control light adjustable device 10D of the embodiment is similar to the touch control light adjustable device 10 of FIG. 1, and a main difference there between is that the touch control light adjustable device 10D further includes a second transparent substrate 120 and a second touch control structure 320D. In detail, the second transparent substrate 120 has a third surface S3 and a fourth surface S4 opposite to each other. The third surface S3 of the second transparent substrate 120 is disposed on the second transparent base board 212 of the macromolecule dispersed liquid crystal composite layer 200. In other words, the macromolecule dispersed liquid crystal composite layer 200 is located between the first surface S1 of the first transparent substrate 110 and the third surface S3 of the second transparent substrate 120. A material of the second transparent substrate 120 is similar to the material of the first transparent substrate 110, so that detail thereof is not repeated. In some embodiments, the touch control light adjustable device 10D is, for example, a smart window including laminated glass, but the disclosure is not limited thereto.

A first touch control structure 310D is disposed on the second surface S2 of the first transparent substrate 110. A second touch structure 320D is disposed on the fourth surface S4 of the second transparent substrate 120. In some embodiments, the third optical adhesive AD3 or a fourth optical adhesive AD4 may be selectively disposed on the third surface S3 or the fourth surface S4 of the second transparent substrate 120, respectively. The third optical adhesive AD3 may be located between the second transparent substrate 120 and the macromolecule dispersed liquid crystal composite layer 200. The fourth optical adhesive AD4 may be located between the second transparent substrate 120 and the second touch control structure 320D. The second transparent substrate 120 is located between the macromolecule dispersed liquid crystal composite layer 200 and the second touch control structure 320D. Materials of the third optical adhesive AD3 and the fourth optical adhesive AD4 are similar to the material of the first optical adhesive AD1, so that detail thereof is not repeated.

Under the above configuration, the touch control light adjustable device 10D may be provided with transparent substrates (for example, glass) on two opposite sides of the macromolecule dispersed liquid crystal composite layer 200. Therefore, the macromolecule dispersed liquid crystal composite layer 200 may be further protected from the influence of moisture or oxygen in the environment. In addition, the touch control light adjustable device 10D may also have the advantage of the laminated glass through the first transparent substrate 110 and the second transparent substrate 120, which further provides the user with an excellent user experience. Moreover, the user may operate the touch control light adjustable device 10D on any of the opposite surfaces of the touch control light adjustable device 10D to implement light-transmitting or opaque changes. In this way, the usage convenience or operability of the touch control light adjustable device 10D may be further improved. In addition, the touch control light adjustable device 10D may also achieve the same effect as that of the aforementioned embodiment.

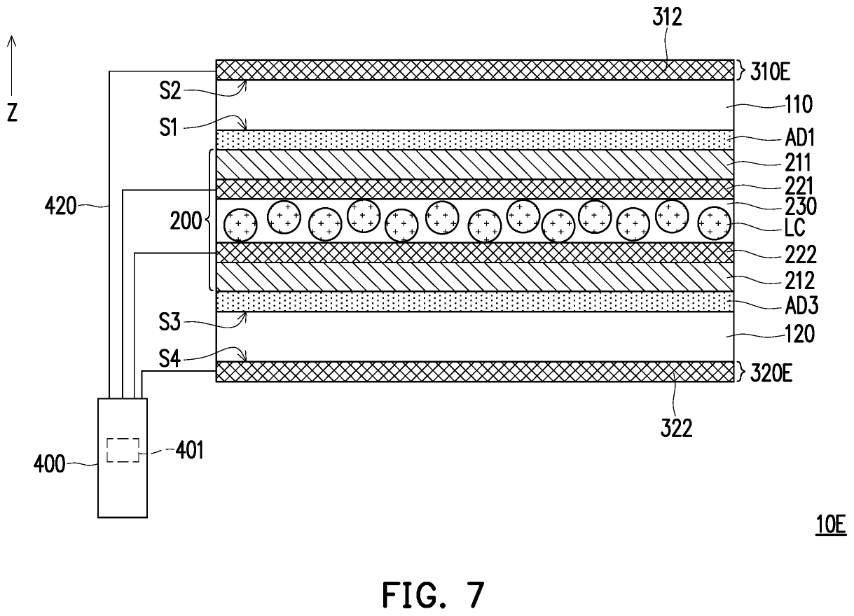

FIG. 7 is a schematic cross-sectional view of a touch control light adjustable device according to still another embodiment of the disclosure. For the clarity's sake of the drawings and the convenience of description, several elements are omitted in FIG. 7. Referring to FIG. 7 and FIG. 6, a touch control light adjustable device 10E of the embodiment is similar to the touch control light adjustable device 10D of FIG. 1, and a main difference there between is that a first touch control structure 310E includes the transparent conductive material layer 312 and omits the transparent material layer, and a second touch control structure 320E includes the transparent conductive material layer 322 and omits the transparent material layer. The transparent conductive material layer 312 may be directly disposed on the second surface S2 of the first transparent substrate 110. The transparent conductive material layer 322 may be directly disposed on the fourth surface S4 of the second transparent substrate 120. A method of forming the transparent conductive material layer 322 is similar to the method of forming the transparent conductive layer 312, so that detail thereof is not repeated. In this way, the first touch control structure 310E and the second touch control structure 320E may be simply formed by a deposition or coating manufacturing process. Therefore, the structure of the touch control light adjustable device 10E may be further simplified to reduce a thickness thereof. In addition, the touch control light adjustable device 10E also has the advantages of a further simplified manufacturing process and cost saving.

In summary, in the touch control light adjustable device of the embodiment of the disclosure, since the macromolecule dispersed liquid crystal composite layer and the first touch control structure are electrically connected to the driving circuit, the user may operate (for example, touch) a transparent conductive material of the first touch control structure to change the capacitance value of at least one capacitor 401 in the driving circuit 400. The driving circuit may provide a voltage signal to the macromolecule dispersed liquid crystal composite layer based on the change of the capacitance value of at least one capacitor 401 in the driving circuit 400 caused by the user's operation to drive a corresponding area of the macromolecule dispersed liquid crystal composite layer to implement partial or overall light-transmitting and opaque changes. In this way, the touch control light adjustable device may implement light-transmitting and opaque changes through the user's touch operation, so as to achieve improved usability and operability. In addition, according to the manufacturing method of the touch control light adjustable device of the embodiment, since the macromolecule dispersed liquid crystal composite layer and the first touch control structure may be simply and directly disposed on the two opposite surfaces of the first transparent substrate and are then electrically connected to the driving circuit to complete the manufacturing process, the touch control light adjustable device may thereby feature a simple structure, requires only a simple manufacturing process, and may achieve cost saving.

In addition, the touch control light adjustable device according to an embodiment of the disclosure may also be a smart window or a display device with a touch function on both sides. In this way, the user may operate the touch control light adjustable device on any of the two opposite surfaces of the touch control light adjustable device to implement light-transmitting or opaque changes. In this way, the usability or operability of the touch control light adjustable device may be further improved. In addition, the touch control light adjustable device may also achieve the same effect as that of the aforementioned embodiments.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A touch control light adjustable device, comprising:
a first transparent substrate, having a first surface and a second surface opposite to each other;
a macromolecule dispersed liquid crystal composite layer, disposed on the first surface of the first transparent substrate;
a first touch control structure, disposed on the second surface of the first transparent substrate; and
a driving circuit, the macromolecule dispersed liquid crystal composite layer and the first touch control structure being electrically connected to the driving circuit,
wherein the driving circuit provides a voltage signal to drive the macromolecule dispersed liquid crystal composite layer based on a change of a capacitance value of at least one capacitor in the driving circuit by touching the surface of the first touch control structure.

2. The touch control light adjustable device according to claim 1, wherein the macromolecule dispersed liquid crystal composite layer comprises:
a first transparent base board;
a first transparent conductive layer, disposed on the first transparent base board;
a second transparent base board, disposed opposite to the first transparent base board;
a second transparent conductive layer, disposed on the second transparent base board; and
a macromolecule dispersed liquid crystal layer, disposed between the first transparent conductive layer and the second transparent conductive layer.

3. The touch control light adjustable device according to claim 1, wherein the first transparent conductive layer or the second transparent conductive layer is electrically connected to the driving circuit.

4. The touch control light adjustable device according to claim 1, wherein the first touch control structure comprises:
a transparent material layer; and
a transparent conductive material layer, disposed on the transparent material layer.

5. The touch control light adjustable device according to claim 1, wherein the transparent material layer comprises polyethylene terephthalate, polyethylene, polyimide, nylon, polyurethane, or acrylic plastic.

6. The touch control light adjustable device according to claim 1, wherein the first touch control structure comprises:
a transparent conductive material layer, wherein the transparent conductive material layer is directly disposed on the second surface of the first transparent substrate.

7. The touch control light adjustable device according to claim 1, further comprising a first optical adhesive layer and a second optical adhesive layer, wherein the first optical adhesive layer is disposed between the first transparent substrate and the macromolecule dispersed liquid crystal composite layer, and the second optical adhesive layer is disposed between the first transparent substrate and the first touch control structure.

8. The touch control light adjustable device according to claim 1, further comprising a second touch control structure disposed on the macromolecule dispersed liquid crystal composite layer, wherein the macromolecule dispersed liquid crystal composite layer is located between the first transparent substrate and the second touch control structure.

9. The touch control light adjustable device according to claim 1, further comprising:
a second transparent substrate, having a third surface and a fourth surface opposite to each other, wherein the macromolecule dispersed liquid crystal composite layer is located between the first surface of the first transparent substrate and the third surface of the second transparent substrate; and
a second touch control structure, disposed on the fourth surface of the second transparent substrate, wherein the second transparent substrate is located between the macromolecule dispersed liquid crystal composite layer and the second touch control structure.

10. The touch control light adjustable device according to claim 1, wherein a plurality of macromolecule dispersed liquid crystal composite layers are provided, and the plurality of macromolecule dispersed liquid crystal composite layers are arranged in an array on the first transparent substrate,
wherein a plurality of first touch control structures are provided, and the plurality of first touch control structures are arranged in an array on the first transparent substrate.
